(19) United States
(12) Patent Application Publication
(10) Pub. No.: US 2007/0228112 A1
(43) Pub. Date: Oct. 4, 2007

(54) Method and arrangement for forming a microelectronic package

(76) Inventors: Wei Shi, Gilbert, AZ (US); Thomas J. Fitzgerald, Phoenix, AZ (US); Steve M. Mayer, Mesa, AZ (US); Carl L. Deppisch, Chandler, AZ (US); Daoqiang Lu, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/394,928

(22) Filed: Mar. 31, 2006

(51) Int. Cl. B23K 31/02

(52) U.S. Cl. 228/181; 228/183

(57) ABSTRACT

A method of forming a microelectronic package, and an arrangement to attach a solder preform onto a microelectronic die in order to form the package. The method comprises: providing a reinforced solder preform including a solder preform and a backing layer attached to a backside of the solder preform; placing the reinforced solder preform on a surface of a first microelectronic component adapted to be soldered; attaching the solder preform to the surface of the first microelectronic component after placing the reinforced solder preform; removing the backing layer from the solder preform after placing the reinforced solder preform; placing a second microelectronic component to be soldered onto the solder preform after removing the backing layer; and soldering the second microelectronic component to the first microelectronic component to form the package.

### FIELD OF THE INVENTION

Embodiments of the present invention relate generally to methods and arrangements to place a thin solder preform, such as an In-containing solder preform, onto a surface of a microelectronic component to be soldered.

### BACKGROUND OF THE INVENTION

Microelectronic packages such as those including a heat spreader mechanically and thermally bonded onto the backside of a microelectronic component such as a die sometimes include the use of a thin solder preform as the thermal interface material (TIM) between the heat spreader and the die. Such solder preforms sometimes include a film made either of In or of InAg, the film usually having a thickness of between about 2 and about 4 mils. Solders containing solder elements such as In, InAg, InSn, have become attractive to the extent that they have a lower melting temperature and a higher softness than typical non-In-containing solders, in this way reducing stresses typically visited upon the die during soldering.

In has a melting temperature of about 156 degrees Celsius. Thus, an In-containing solder preform (ICSP) as thin as 2 to 4 mils is very deformable at room temperature and thus difficult to handle during its placement onto the die. In order to take the deformability of an ICSP into account, the prior art proposes placing the ICSP's onto individual, respective pockets of a conveyor belt, as shown for example in the arrangement of FIG. 1.

As seen in FIG. 1, a conveying and placing arrangement 10 for ICSP's 12 includes a conveyor belt 14 including individual pockets 16 adapted to receive respective ICSP's therein. The conveyor belt 14 is conveyed by a series of reels and drums 18 as shown. A vacuum nozzle 20 including a vacuum head 22 secures hold of each ICSP 12 using vacuum, and places the same onto a corresponding pre-package assembly 24 including a die 26 mounted onto a substrate 28. In the shown example, the die further includes a flux layer 30 thereon, although the prior art is not so limited. As seen in FIG. 2, placement of an ICSP 12 onto the pre-package assembly 24 results in an intermediate pre-package assembly 25 including the die 26, the substrate 28, the flux layer 30 and the ICSP 12 disposed on the flux layer. Thereafter, referring to FIG. 3, a further layer of flux 32 may be placed onto the ICSP 12 of intermediate pre-package assembly 25, and an integrated heat spreader (IHS) 34 mounted thereon to yield the pre-solder package 36 as shown. Package 36 may then be subjected to a reflow process in order to solder the IHS to the backside of the die 26 to form a microelectronic package. After reflow, the ICSP 12 serves as the TIM between the IHS and the die.

Referring to the pre-solder package 36 as shown in FIG. 3, flaws associated with the TIM region may include F1, F2 and F3 as shown. Since the ICSP is deformable, its placement inside the conveyor belt pockets 14, as well as its being picked up by the vacuum head 22 of nozzle 20, typically leads to a warped configuration as suggested in FIGS. 1 and 3. As further suggested in FIG. 3, an ICSP may lead to F1 including an absence of flux on a portion of the bottom side of the preform, F2 including significant air entrapment between the ICSP and the IHS, and F3 including a folded preform portion (typically caused by a settling in of the deformable ICSP in the associated conveyor belt pocket as seen in FIGS. 1 and 2 with no flux in between). In addition, a vacuuming thereof by the nozzle head 22 would typically cause the formation of a nipple at the vacuum site on the ICSP (not shown), leading to flaws similar to F2 as described above. As can be easily appreciated, flaws such as F1, F2 and F3 can greatly negatively impact the thermal performance and reliability of the resulting packages after reflow.

In order to address the above problem, one prior art method involves the use of shallower pockets 14 in order to reduce a warpage of the ICSP's before their placement onto the die. However, even in such cases, additional warpage by the vacuum nozzle may still occur.

The prior art fails to provide a reliable and effective method of forming a microelectronic package using a thin solder preform, such as an ICSP.

### BRIEF DESCRIPTION OF THE DRAWINGS

FIG. 1 is a schematic view of a prior art flux arrangement to place a solder preform such as an ICSP onto a die;

FIG. 2 is a side cross-sectional view of a prior art prepackage assembly formed using the arrangement of FIG. 1;

FIG. 3 is a side cross-sectional view of a prior art intermediate prepackage assembly including an integrated heat spreader mounted onto the prepackage assembly of FIG. 2;

FIGS. 4a and 4b are schematic views of a flux arrangement to place a solder preform such as an ICSP onto a die to form a prepackage assembly according to a first embodiment;

FIG. 4c is a side cross-sectional view of an intermediate prepackage assembly including an integrated heat spreader mounted onto the prepackage assembly of FIG. 4b;

FIGS. 5a, 5b and 5d are schematic views of a fluxless arrangement to place a solder preform such as an ICSP onto a die to form a prepackage assembly according to a first embodiment;

FIG. 5c is a top plan view of a portion of the conveyor belt of FIGS. 5a, 5b and 5d;

FIG. 5e is a side cross-sectional view of an intermediate prepackage assembly including an integrated heat spreader mounted onto the prepackage assembly of FIG. 4b;

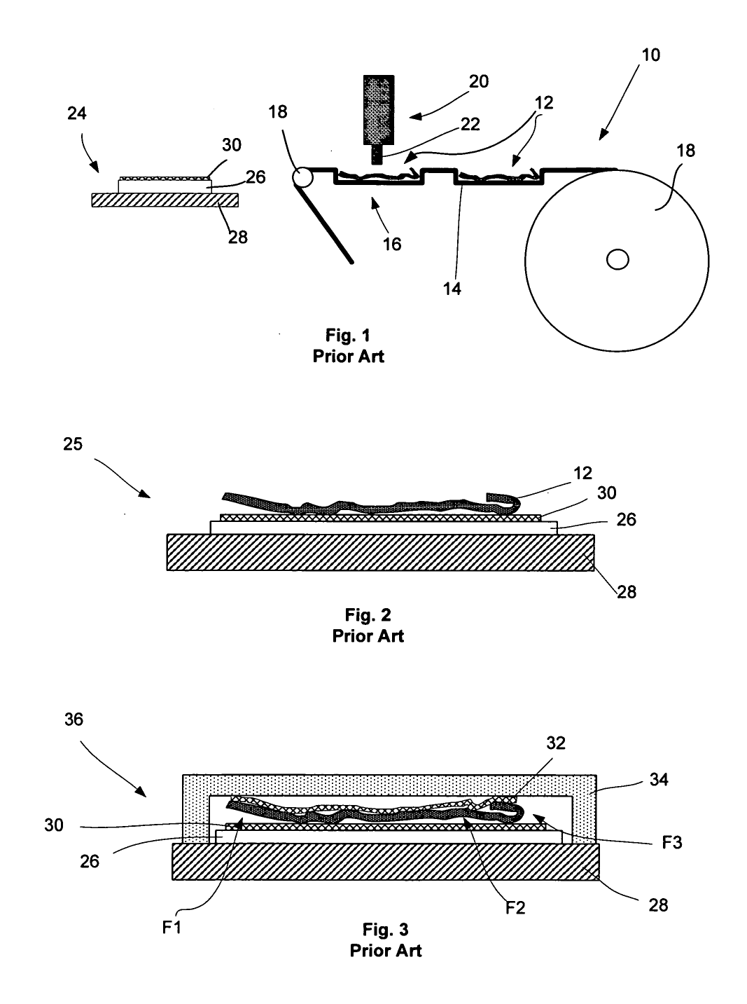

For simplicity and clarity of illustration, elements in the drawings have not necessarily been drawn to scale. For example, the dimensions of some of the elements may be exaggerated relative to other elements for clarity. Where considered appropriate, reference numerals have been repeated among the drawings to indicate corresponding or analogous elements.

### DETAILED DESCRIPTION

In the following detailed description, a method of forming a microelectronic package, an arrangement to attach a solder preform onto a microelectronic component, and a reinforced solder preform are disclosed. Reference is made to the accompanying drawings within which are shown, by way of illustration, specific embodiments by which the present invention may be practiced. It is to be understood that other embodiments may exist and that other structural changes may be made without departing from the scope and spirit of the present invention.

The terms on, above, below, and adjacent as used herein refer to the position of one element relative to other elements. As such, a first element disposed on, above, or below a second element may be directly in contact with the second element or it may include one or more intervening elements. In addition, a first element disposed next to or adjacent a second element may be directly in contact with the second element or it may include one or more intervening elements.

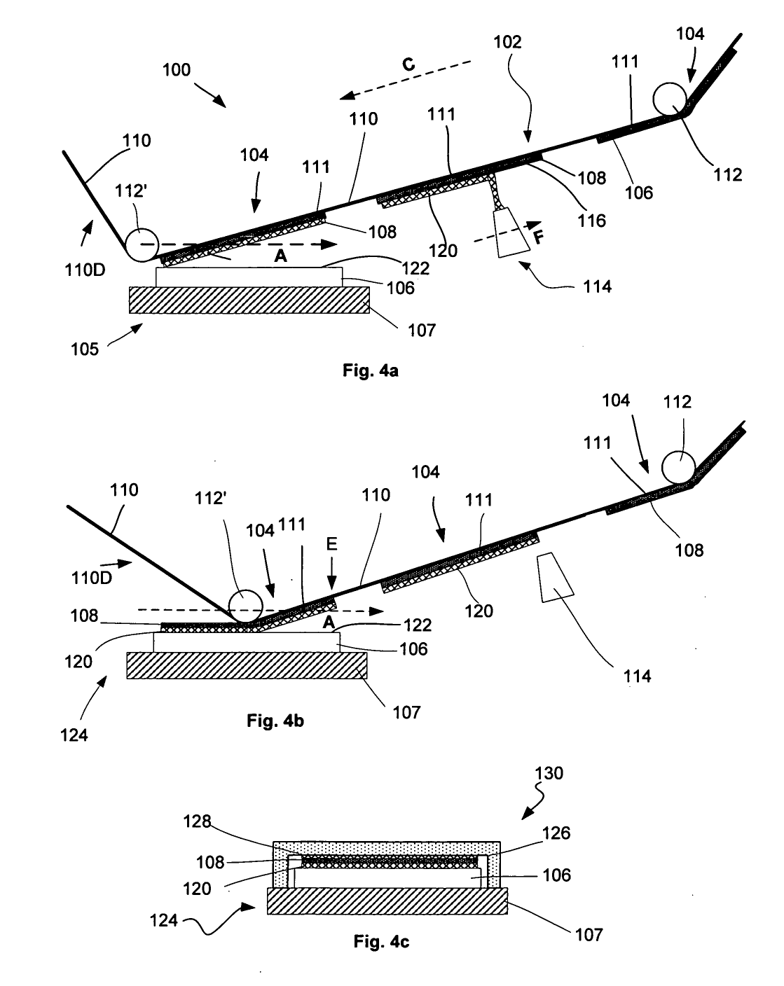

In one embodiment, an arrangement for attaching a solder preform to a microelectronic die using a flux medium is disclosed. In another embodiment, an arrangement for attaching a solder preform to a microelectronic die without the use of a flux medium is disclosed. In one embodiment, a method of forming a microelectronic package is disclosed. In a further embodiment, a reinforced solder preform is disclosed. In a further embodiment, a system is disclosed including a package formed according to the method. Aspects of these and other embodiments will be discussed herein with respect to FIGS. 4a-6, below. The figures, however, should not be taken to be limiting, as they are intended for the purpose of explanation and understanding.

Referring first to FIGS. 4a and 4b by way of example, a first embodiment of the present invention comprises an arrangement for attaching a solder preform to a microelectronic component using a flux medium. For the above reason, the arrangement of FIGS. 4a and 4b will hereinafter be referred to as a “flux arrangement.”

As seen in FIGS. 4a and 4b, flux arrangement 100 according to an embodiment includes a conveying mechanism 102 configured to convey a reinforced solder preform (RSP) 104 to a prepackage assembly 105 including microelectronic die 106 mounted to a substrate 107. The reinforced solder preform includes a solder preform 108, such as, for example, a ICSP in the form of a thin film having a thickness between about 2 to about 4 mils, although it is to be understood that embodiments are applicable to attach solder preforms of any material having any thickness range, as would be recognized by one skilled in the art. The solder preform 108 is shown as having been structurally reinforced at a backside thereof by a portion 111 of a conveyor belt 110 attached thereto. FIGS. 4a and 4b show three RSP's 104, each including a solder preform 108 reinforced by portion 111 of belt 110, each portion 111 representing a backing layer of a corresponding one of the RSP's 104. In the shown embodiment, the conveyor belt 110, which is a part of conveying mechanism 102, is in the form of an adhesive tape, such as, for example, an adhesive tape comprising a Mylar®, (a registered trademark of DuPont-Teijin Films, Inc.) polyester film provided with an adhesive coating on its die-side. According to an embodiment, the adhesive tape may have a thickness between about 2 mils and about 4 mils It is noted, however, that embodiments are not limited to the use of a conveyor belt in the form of a tape, and include within their scope the use of a conveyor belt not in the form of a tape, which is adapted to convey reinforced solder preforms thereon. The conveying mechanism 102 further includes a plurality of rotatable drums such as drums 112 and 112′ adapted to convey conveyor belt 110 in the conveying direction C as shown. Drums 112 may be rotated by any one of well known drum rotation mechanisms (not shown), as would be within the knowledge of one skilled in the art. Belt 110 may be tensioned at a portion 110D thereof downstream of rotatable drum 112′ by any well known device as would be readily recognizable to one skilled in the art, such as, for example, a further rotatable drum (not shown).

The arrangement further comprises an attachment mechanism to attach the solder preform of each RSP to the surface of the die to be soldered, which, in the shown example, includes a backside of the die 106. In the shown embodiment, the attachment mechanism encompasses the drum 112′ as will be described further below, and, in addition, a flux dispensing device, such as, in the shown example, in the form of a flux spray nozzle 114. Flux spray nozzle 114 may be provided upstream of the rotatable drum 112′ to dispense a layer of flux 120 to a front surface 116 of each RSP prior to a placing of the associated solder preform onto the die. According to one embodiment, the flux spray nozzle 114 may be configured to be translatable with respect to the front surface 116 of each RSP in the F direction as shown in order to allow an even distribution of flux thereon in the form of layer 120 as shown.

Referring still to FIGS. 4a and 4b, in the shown embodiment, rotatable drum 112′ not only forms a part of the conveying mechanism 102, but further serves as part of the attachment mechanism of the arrangement 100 in order to effect an attachment of the solder preform onto the backside of die 106. In particular, according to FIGS. 4a and 4b, rotatable drum 112 may be adapted to move in the advancing direction after placement of the RSP 104 in position above the backside 122 of die 106 as shown in FIG. 4a. By placement of the RSP “in position” or “in registration,” what is meant in the context of the present description is a placement of the RSP in registration with the surface of the microelectronic component to be soldered (such as, in the shown embodiment, backside 122 of die 106) such that application of pressure onto the RSP in a direction toward the surface of the microelectronic component would place the solder preform in contact with and in registration with the surface of the microelectronic component. Thus, as seen in FIG. 4a, the RSP 104 closest of rotatable drum 112′ is shown as having been placed in position above backside 122 of die 106. Thus, an application of pressure onto the RSP 104 closest to the rotatable drum 112′ by drum 112′ places the solder preform 108 of the RSP 104 in contact with and in registration with the backside 122 of die 106, as shown in particular in FIG. 4. After placement of each RSP 104 in position above backside 122 of die 106, the conveying mechanism 102 may, according to the shown embodiment, halt a moving of the conveyor belt in the conveying direction C. At such time, the rotatable drum 112′ may move in the advancing direction A such as by rolling in a manner to apply a pressure to the backside of the RSP 104 to generate a pressure between the solder preform 108 and backside 122 of die 106. The pressure thus generated may have a value that is effective to attach the preform onto the sticky flux layer 120, but not high enough to force the flux of layer 120 out from between the die and the RSP. Where the solder preform is made of In or InAg and the flux includes resin based acid, the pressure applied by roller 112′ onto the backside of the RSP 104 may be between about 0.5 lb and about 10 lbs, and preferably between about 1 lb and about 2 lbs. As suggested in FIGS. 4a and 4b, the rotatable drum 112′ may move across a length of each RSP after a placement in position of the RSP in order to contribute to an attachment of the solder preform 108 to the backside 122 of die 106. The presence of the layer of flux 120 facilitates an adhesion of the solder preform 108 to the backside 122 of die 106 as suggested in FIG. 4b.

Referring in particular to FIG. 4b by way of example, the flux arrangement 100 includes a removing mechanism to remove the backing layer from the solder preform after attaching the solder preform. In the embodiment of FIG. 4b, the removing mechanism comprises the conveying mechanism 102 configured such that a rolling of rotatable drum 112′ across a backside of the backing layer or portion 111 causes the belt 110 to be pulled away from the solder preform 108 to remove the portion 111 from the preform 108 after attachment of the preform 108 to the die 106. As best seen in FIG. 4b, the conveying mechanism is configured, in particular downstream of rotatable drum 112′ at portion 110D of belt 110, such that, an attachment of the solder preform 108 to the backside 122 of die 106 by way of a moving of rotatable drum 112′ onto the backside of portion 111 of belt 110 causes the belt to diverge away from and separate from the preform 108. In the shown embodiment, the conveyor belt 110 may still be in a halted state during an advancement of the rotatable drum 110 and after a stopping of the rotatable drum 112′ at the edge E of the portion 111 of belt 110 when the solder preform 108 is attached along its length to the backside 122 of die 106. An attachment of the solder preform 108 onto the backside 122 of die 106 mounted onto substrate 107 results in the formation of an intermediate pre-package assembly 124 including the solder preform 108, flux layer 120, die 106 and substrate 107 as shown.

Referring next to FIG. 4c by way of example, after an attachment of preform 108 onto backside 122 by way of the flux arrangement 100, a second microelectronic component, such as in the form of an integrated heat spreader or IHS 126 may be bonded to the intermediate pre-package assembly 124 via the solder preform 108 in a well known manner. Thus, as shown in the exemplary embodiment of FIG. 4c, a second layer of flux 128 may be dispensed onto the solder preform 108 after its attachment to the die 106, after which the IHS 126 may be placed onto the second layer of flux 128 and soldered onto the backside 122 of microelectronic die 106, in a known manner, such as by being placed in a reflow oven. The resulting product may comprise a package 130 as shown in FIG. 4c.

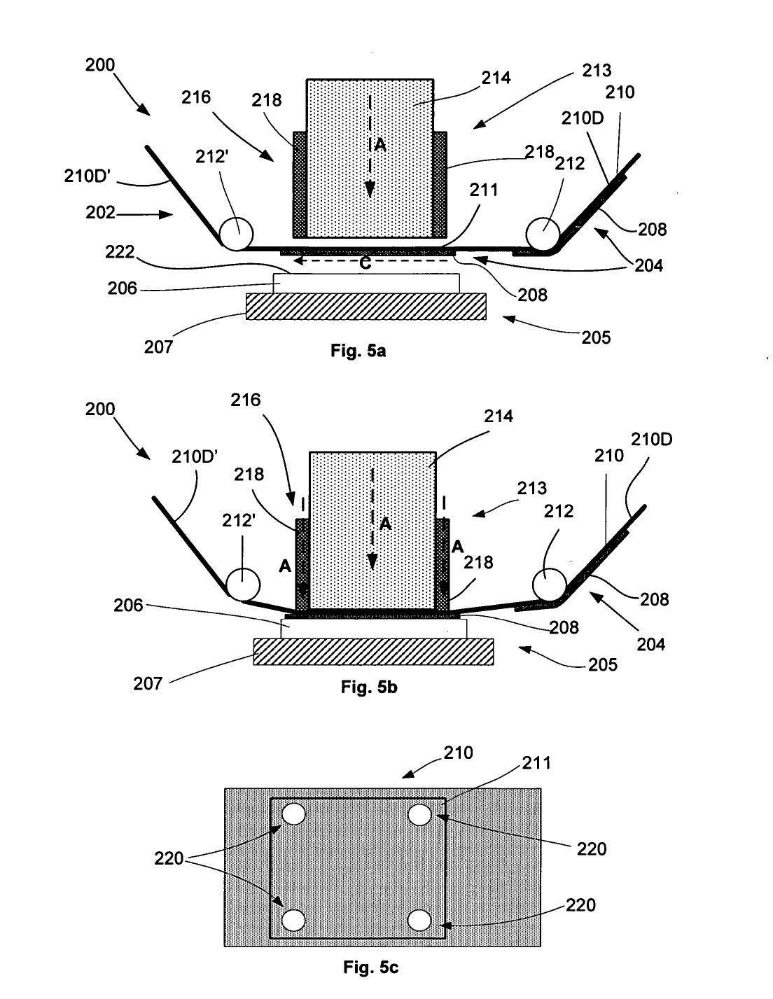

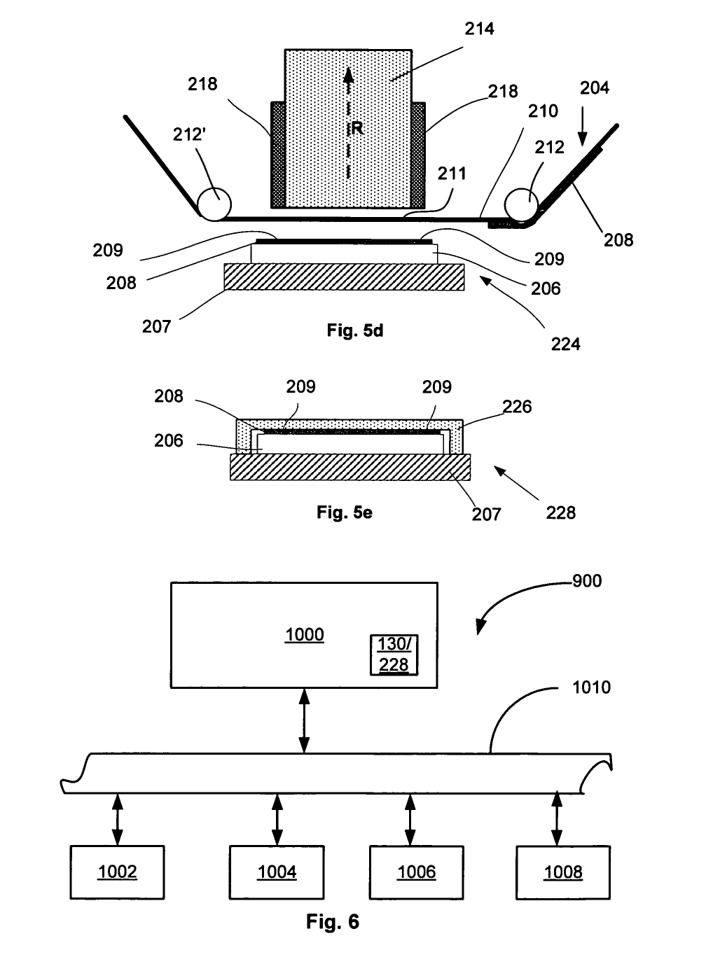

Referring first to FIGS. 5a, 5b and 5d by way of example, a second embodiment of the present invention comprises an arrangement for attaching a solder preform to a microelectronic die without the use of flux medium. For the above reason, the arrangement of FIGS. 5a, 5b and 5d will hereinafter be referred to as the “fluxless arrangement.” As seen in FIGS. 5a, 5b and 5d, fluxless arrangement 200 according to an embodiment includes a conveying mechanism 202 configured to convey a reinforced solder preform (RSP) 204 to a prepackage assembly 205 including microelectronic die 206 mounted to a substrate 207. The reinforced solder preform includes a solder preform 208, such as, for example, a ICSP in the form of a thin film having a thickness between about 2 mils and about 4 mils, although it is to be understood that embodiments are adapted to convey and attach solder preforms having any thickness range, as would be recognized by one skilled in the art. The solder preform 208 is shown as having been structurally reinforced at a backside thereof by a portion 211 of a conveyor belt 210 attached thereto. FIGS. 5a and 5b show two RSP's 204, each being processed by arrangement 200, and each including a solder preform 208 reinforced by portion 211 of belt 210, each portion 211 representing a backing layer to a corresponding one of the RSP's 204. In the shown embodiment, the conveyor belt 210, which is a part of conveying mechanism 202, is in the form of an adhesive tape, such as, for example, an adhesive tape comprising a Mylar®, (a registered trademark of DuPont-Teijin Films, Inc.) polyester film provided with an adhesive coating on its die-side. According to an embodiment, the adhesive tape may have a thickness between about 2 mils and about 4 mils. As noted above, embodiments are, however, not limited to the use of a conveyor belt in the form of a tape, and include within their scope the use of a conveyor belt not in the form of a tape, which is adapted to convey reinforced solder preforms thereon. The conveying mechanism 202 further includes a plurality of rotatable drums such as drums 212 and 212′ adapted to convey conveyor belt 210 in the conveying direction C as shown. Drums 212 and 212′ may be rotated by any one of well known drum rotation mechanisms (not shown), as would be within the knowledge of one skilled in the art. Belt 210 may be tensioned at a portions 210D and 210D′ thereof upstream of rotatable drum 212 and downstream of rotatable drum 212′, respectively, by any well known device as would be readily recognizable to one skilled in the art, such as, for example, further rotatable drums (not shown). The arrangement may further comprise an attachment mechanism 213 to attach the solder preform of each RSP to the surface of the die to be soldered, which, in the shown example, includes a backside 222 of the die 206. In the shown embodiment, the attachment mechanism 213 encompasses a pressing head 214 adapted to press against a backside of backing layer, or portion 211 of belt 210 when the RSP is placed in position with respect to backside 222 of die 206. In addition, attachment mechanism 213 may further include a bonding mechanism 216 to effect a fluxless attachment of the solder preform 208 to the backside 222 of die 206. In particular, according to FIGS. 5a and 5b, pressing head 214 may be adapted to move in the advancing direction A after placement of the RSP 204 in position above the backside 222 of die 206 as shown in FIG. 5a. As noted above with respect to the embodiment of FIGS. 4a and 4b, by placement of the RSP “in position,” what is meant in the context of the present description is a placement of the RSP in registration with the surface of the microelectronic component to be soldered (such as, in the shown embodiment, backside 222 of die 206) such that application of pressure onto the RSP in a direction of the surface of the microelectronic component would place the solder preform in contact with and in registration with the surface of the microelectronic component. Thus, as seen in FIG. 5a, the RSP 204 closest to the attachment mechanism 213 is shown as having been placed in position above backside 222 of die 206. Thus, an application of pressure onto the RSP 204 closest to the attachment mechanism 213 by a pressing thereof toward backside 222 of die 206 using the pressing head 214 places the solder preform 208 of the RSP 204 in contact with and in registration with the backside 222 of die 206, as shown in particular in FIG. 5b. After placement of each RSP 204 in position above backside 222 of die 206, the conveying mechanism 202 may, according to the shown embodiment, halt a moving of the conveyor belt in the conveying direction C. At such time, the pressing head 214 may move in the advancing direction A to apply a pressure to the backside of the RSP 204 to generate a pressure between the solder preform 208 and the surface of the microelectronic component adapted to be soldered, this surface corresponding in the shown embodiment to backside 222 of die 206. Typically, where the solder preform is made of In or InAg, the pressure applied by onto the backside of the RSP 204 is between about 0.5 lb and about 20 lbs, and preferably between about 2 lb and about 4 lbs. As suggested in FIGS. 5a and 5b, the pressing head 214 may move in the advancing direction A to hold the solder preform 208 onto the backside 222 of die 206 during an attachment of the preform to the die by the bonding mechanism 216. Thus, after the pressing head 214 moves downward in the advancing direction A to its final position, which position places the preform 208 in contact with the backside 222 of die 206 and generates a holding pressure between the preform and the backside of the die, the bonding mechanism 216 moves also in the advancing direction A to bond or attach the preform to the backside of the die. In the shown embodiment, bonding mechanism 216 may comprise any device that allows a direct bonding of the preform to the die as would be within the knowledge of a person skilled in the art, such as, for example, a spot welding device, a laser welding device or an ultrasonic bonding device. In the shown embodiment, the bonding mechanism 216 may include bonding posts 218 which are adapted to move down to contact the preform 208 through the backing layer or portion 211 in order to directly bond the preform to the die. For the above purpose, the backing layer or portion 211 may define openings therein to allow corresponding of the bonding posts to pass therethrough to bond the preform to the die.

In particular, referring to FIG. 5c, the backing layer or portion 211 may define openings 220 therein, such as, for example, openings shaped and distributed as shown in FIG. 5c. It is noted that the backing layer configuration of FIG. 5c is merely exemplary. Embodiments comprise within their scope the provision of openings in the backing layer shaped and distributed in any manner that would allow a passing therethrough of one or more corresponding bonding posts of any suitable bonding mechanism, as would be recognizable by one skilled in the art. In the shown embodiment, the RSP may be placed in position above the die when the openings defined in the backing layer are placed in registration with the bonding posts of the bonding mechanism. Thus, after a full descent of the pressing head 214 onto the backside of the backing layer or portion 211 as shown in FIG. 5b, the bonding posts 216 may descend through the openings 220 to contact the preform 208 in order to bond the preform to the backside 222 of die 206 at bonded solder locations 209, such as, for example, via spot welding, laser welding or ultrasonic bonding.

Referring in particular to FIGS. 5b and 5d by way of example, the fluxless arrangement 200 further includes a removing mechanism to remove the backing layer from the solder preform after attaching the solder preform. In the shown embodiment, the removing mechanism comprises the conveying mechanism 202 configured such that a retracting of the pressing head 214 and of the bonding mechanism 216 causes the belt 210 to be pulled away from the solder preform 208 to remove the belt 210 and portion 211 from the solder preform 208 to remove the portion 211 from the preform 208 after attachment of the preform 208 to the die 206. As best seen in FIGS. 5b and 5d, the conveying mechanism is configured, in particular upstream of rotatable drum 212 at portion 210D of belt 210, and downstream of rotatable drum 212′ at portion 210D′ of belt 210, such that a retraction of the pressing head 214 and of the bonding mechanism 216 in the retraction direction R causes the belt to be free to separate from the preform 208. In the shown embodiment, the conveyor belt 210 may still be in a halted state during a descent of the pressing head 214 and of the bonding posts 218 when the solder preform 208 is attached to the backside 222 of die 206. Thus, the removing mechanism in the fluxless arrangement 200 comprises the pressing head 214, the conveyor belt 110 and a tensioning mechanism including the two rotatable drums 212 and 212′ positioned and configured such that a releasing of the pressing head 214 from a backside of the backing layer or portion 211 causes the tensioning mechanism to pull the belt 210 away from the solder preform 208 to remove the backing layer or portion 211 from the preform after attachment of the preform to the die. In the alternative, after a releasing of the pressing head 214, from the backside of the preform 208, the conveying mechanism could begin moving the belt 210 in the conveying direction, in this way pulling the belt away from the backside of preform 208. An attachment of the solder preform 208 onto the backside 222 of die 206 mounted onto substrate 207 holds the solder preform flat on the die during subsequent processing, and anchors the same, resulting in the formation of an intermediate pre-package assembly 224 shown in FIG. 5d including the solder preform 208, die 206 and substrate 207 as shown.

Referring next to FIG. 5e by way of example, after an attachment of preform 208 onto backside 222 by way of the fluxless arrangement 200, a second microelectronic component, such as in the form of an integrated heat spreader or “IHS” 226 may be bonded to the intermediate pre-package assembly 224 via the solder preform 208 in a well known manner. Thus, as shown in the exemplary embodiment of FIG. 5d, the IHS 226 may be placed onto the preform 208 and soldered onto the backside 222 of microelectronic die 206, in a known manner, such as by being placed in a reflow oven. The resulting product may comprise a package 228 as shown in FIG. 5d.

Although exemplary embodiments of a flux arrangement and of a fluxless arrangement to attach a solder preform to a microelectronic die have been shown with respect to FIGS. 4a-4c and 5a-5d respectively, embodiments comprise within their scope any other configurations of such arrangements, as would be within the knowledge of a person skilled in the art. In addition, although exemplary methods have been set forth above, it is understood that other methods would be within the purview of embodiments.

In addition, it is noted that embodiments are not limited to an RSP where the backing layer corresponds to a portion of a conveyor belt. Rather, embodiments comprise within their scope an RSP where the backing layer is a discrete element attached to the backside of the preform, such as, for example, a backing layer that is substantially co-extensive with the backside of the solder preform. Such an RSP may even, according to embodiments, be used to manually attach the solder preform to a surface of a microelectronic element to be soldered.

Advantageously, embodiments provide a reliable and effective method and arrangement of forming a microelectronic package using a thin solder preform, such as an ICSP. Embodiments substantially eliminate preform warpage before and during attachment to a microelectronic component such as a die, substantially eliminate air entrapment between the microelectronic component and other such components soldered thereto by way of the preform, in this way enhancing device performance. In addition, embodiments provide a cost-effective, high-volume-manufacturing-friendly arrangement and process for attaching a solder preform such as an ICSP to a die.

Referring to FIG. 6, there is illustrated one of many possible systems 900 in which embodiments of the present invention may be used. In one embodiment, the electronic assembly 1000 may include a microelectronic package, such as package 130 of FIG. 4c or package 228 of FIG. 5e. Assembly 1000 may further include a microprocessor. In an alternate embodiment, the electronic assembly 1000 may include an application specific IC (ASIC). Integrated circuits found in chipsets (e.g., graphics, sound, and control chipsets) may also be packaged in accordance with embodiments of this invention.

For the embodiment depicted by FIG. 6, the system 90 may also include a main memory 1002, a graphics processor 1004, a mass storage device 1006, and/or an input/output module 1008 coupled to each other by way of a bus 1010, as shown. Examples of the memory 1002 include but are not limited to static random access memory (SRAM) and dynamic random access memory (DRAM). Examples of the mass storage device 1006 include but are not limited to a hard disk drive, a compact disk drive (CD), a digital versatile disk drive (DVD), and so forth. Examples of the input/output module 1008 include but are not limited to a keyboard, cursor control arrangements, a display, a network interface, and so forth. Examples of the bus 1010 include but are not limited to a peripheral control interface (PCI) bus, and Industry Standard Architecture (ISA) bus, and so forth. In various embodiments, the system 90 may be a wireless mobile phone, a personal digital assistant, a pocket PC, a tablet PC, a notebook PC, a desktop computer, a set-top box, a media-center PC, a DVD player, and a server.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. A method of forming a microelectronic package comprising:
providing a reinforced solder preform including a solder preform and a backing layer attached to a backside of the solder preform;
placing the reinforced solder preform on a surface of a first microelectronic component adapted to be soldered;
attaching the solder preform to the surface of the first microelectronic component after placing the reinforced solder preform;
removing the backing layer from the solder preform after placing the reinforced solder preform;
placing a second microelectronic component to be soldered onto the solder preform after removing the backing layer; and
soldering the second microelectronic component to the first microelectronic component to form the package.

2. The method of claim 1, wherein removing comprises removing the backing layer one of during and after attaching.

3. The method of claim 1, wherein attaching comprises generating a pressure between the solder preform and the surface of the first microelectronic component.

4. The method of claim 3, wherein the pressure is between about 0.5 lb and about 10 lbs.

5. The method of claim 4, wherein the pressure is between about 1 lb and about 2 lbs.

6. The method of claim 3, wherein attaching comprises applying a pressure to a backside of the reinforced solder preform to generate the pressure between the solder preform and the surface of the first microelectronic component.

7. The method of claim 3, wherein attaching comprises:
providing a flux material between the solder preform and the surface of the first microelectronic component; and
applying the pressure after providing the flux material.

8. The method of claim 7, wherein providing the flux material comprises applying the flux material to a front surface of the reinforced solder preform.

9. The method of claim 7, wherein applying the pressure comprises rolling a rotatable drum across a backside of the reinforced solder preform.

10. The method of claim 3, wherein attaching comprises effecting a fluxless attachment of the solder preform to the surface of the first microelectronic die.

11. The method of claim 10, wherein effecting a fluxless attachment comprises effecting an attachment of the solder preform to the surface of the first microelectronic die using one of laser welding, spot welding and ultrasonic bonding.

12. The method of claim 10, wherein generating a pressure occurs during effecting a fluxless attachment.

13. The method of claim 10, wherein the backing layer defines at least one opening therein, and effecting the fluxless attachment comprises accessing the solder preform through the at least one opening.

14. The method of claim 1, wherein the backing layer comprises an adhesive tape, and the reinforced solder preform comprises the solder preform and the adhesive tape adhered to a backside of the solder preform.

15. The method of claim 14, wherein the backing layer comprises an elongated adhesive tape, and the reinforced solder preform comprises the solder preform and a portion of the elongated adhesive tape adhered to a backside of the solder preform.

16. The method of claim 15, wherein placing comprises:
providing a conveyor belt and roller arrangement adapted to convey the elongated adhesive tape;
conveying the elongated adhesive tape to a position that is in registration with the surface of the first microelectronic component;
bringing a front surface of the solder preform in contact with the surface of the first microelectronic component.

17. The method of claim 1, wherein the first microelectronic component comprises a microelectronic die, and the surface comprises a backside of the die.

18. The method of claim 17, wherein the second microelectronic component comprises a heat sink.

19. The method of claim 1, wherein the solder preform comprises Indium.

20. An arrangement to attach a solder preform onto a microelectronic die, the arrangement comprising:
a conveying mechanism to convey a reinforced solder preform to the microelectronic die, the reinforced solder preform including a solder preform and a backing layer attached to a backside of the solder preform;
an attachment mechanism to attach the solder preform to a surface of a microelectronic component to be soldered; and
a removing mechanism to remove the backing layer from the solder preform after attaching the solder preform.

21. The arrangement of claim 20, wherein the conveying mechanism comprises a conveyor belt, a portion of the conveyor belt forming the backing layer attached to the backside of the solder preform.

22. The arrangement of claim 21, wherein the attachment mechanism comprises a rotatable drum adapted to roll across and apply a pressure to a backside of the backing layer when the reinforced solder preform is disposed in registration with the die.

23. The arrangement of claim 20, wherein the attachment mechanism comprises a flux dispensing device adapted to dispense flux to a front surface of the reinforced solder preform before the reinforced solder preform is attached to the die.

24. The arrangement of claim 21, wherein the attachment mechanism comprises a pressing head adapted to press against a backside of the backing layer when the reinforced solder preform is disposed in registration with the die.

25. The arrangement of claim 24, wherein the attachment mechanism further comprises a bonding mechanism to effect a fluxless attachment of the solder preform to the die.

26. The arrangement of claim 25, wherein a bonding mechanism to effect comprises one of a spot welding device, a laser welding device and an ultrasonic bonding device.

27. The arrangement of claim 23, wherein the removing mechanism comprises the rotatable drum, the conveyor belt, and a tensioning mechanism to tension the belt away from the backing layer, the rotatable drum, the belt and the tensioning mechanism being positioned and configured such that a rolling of the rotatable drum across a backside of the backing layer causes the tensioning mechanism to pull the belt away from the solder preform to remove the backing layer from the preform after attachment of the preform to the die.

28. The arrangement of claim 24, wherein the removing mechanism comprises the pressing head, the conveyor belt and a tensioning mechanism to tension the belt away from the backing layer, the pressing head, the belt and the tensioning mechanism being positioned and configured such that a releasing of the pressing head from a backside of the backing layer causes the tensioning mechanism to pull the belt away from the solder preform to remove the backing layer from the preform after attachment of the preform to the die.

29. A reinforced solder preform adapted to be attached to a microelectronic component, the reinforced solder preform including a solder preform and a backing layer attached to a backside of the solder preform.

30. The reinforced solder preform of claim 29, wherein the solder preform contains In.
